(19) United States
(12) Patent Application Publication
(10) Pub. No.: US 2012/0285483 A1
(43) Pub. Date: Nov. 15, 2012

(54) METHOD OF CLEANING A WAFER

(76) Inventors: Li-Chung Liu, Taichung City (TW); Yi-Nan Chen, Taipei City (TW); Hsien-Wen Liu, Taoyuan County (TW)

(21) Appl. No.: 13/106,816

(22) Filed: May 12, 2011

(51) Int. Cl. B08B 1/00

(52) U.S. Cl. 134/6

(57) ABSTRACT

A method of cleaning a wafer is disclosed in the present invention. This method is particularly suitable for cleaning the metal layer on the wafer. First, a wafer having a metal layer is loaded into a cleaning chamber, wherein a plurality of particles are inlaid in a surface of the metal layer. Later, a first clean stage is performed to rinse the wafer by jetted liquid introduced with megasonic energy. After the first clean stage, a second clean stage is performed to scrub the wafer. Finally, the wafer is dried.

### BACKGROUND OF THE INVENTION

1. Field of the Invention

In general, the present invention relates to a clean process of cleaning a wafer, and more particularly, the present invention relates a clean process for cleaning particles on a metal layer.

2. Description of the Prior Art

Semiconductor processing involves a number of different chemical and physical processes whereby minute integrated circuits are created on a substrate. Metal layers which make up the integrated circuit are created by a chemical vapor deposition process, a physical vapor deposition process, and an epitaxial growth process. Al or a conventional Al—Cu alloy have been widely used as a construction material for semiconductor fabrication equipment, at times because of its conductive properties, and generally because of its ease in fabrication and its availability at a reasonable price.

However, it is possible to influence the following fabricating process if some unwanted particles are on the surface of the formed metal layers.

### SUMMARY OF THE INVENTION

It is one object of the present invention to provide a method of cleaning a wafer in order to solve the above-mentioned prior art problems.

To these ends, according to one aspect of the present invention, a method of cleaning a wafer includes the following steps. First, a wafer is loaded into a cleaning chamber. Then, a first clean stage is performed to rinse the wafer by jetted liquid introduced with megasonic energy. After the first clean stage, a second clean stage is performed to scrub the wafer. Finally, the wafer is dried.

From another aspect of this invention, a method of cleaning a wafer includes: first, a wafer having a metal layer is loaded into a cleaning chamber, wherein a plurality of particles are inlaid in a surface of the metal layer. Later, a first clean stage is performed to rinse the wafer by jetted liquid introduced with megasonic energy. After the first clean stage, a second clean stage is performed to scrub the wafer. Finally, the wafer is dried.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic diagram showing germane parts of a wafer clean chamber in accordance with a preferred embodiment of the present invention.

FIG. 2 is a flow chart depicting a method of cleaning wafer.

FIG. 3 is a schematic diagram showing a wafer with a metal layer thereon.

FIG. 4 to FIG. 7 are experimental charts showing chips applied with the conventional clean method and the clean method of the present invention.

### DETAILED DESCRIPTION

In the following description, numerous specific details are given to provide a thorough understanding of the invention. However, it will be apparent to one skilled in the art that the invention may be practiced without these specific details. In order to avoid obscuring the present invention, some well-known system configurations and process steps are not disclosed in detail. The drawings showing embodiments of the apparatus are semi-diagrammatic and not to scale and, particularly, some of the dimensions are for the clarity of presentation and are shown exaggerated in the figures. Also, where multiple embodiments are disclosed and described having some features in common, for clarity and ease of illustration and description thereof like or similar features one to another will ordinarily be described with like reference numerals.

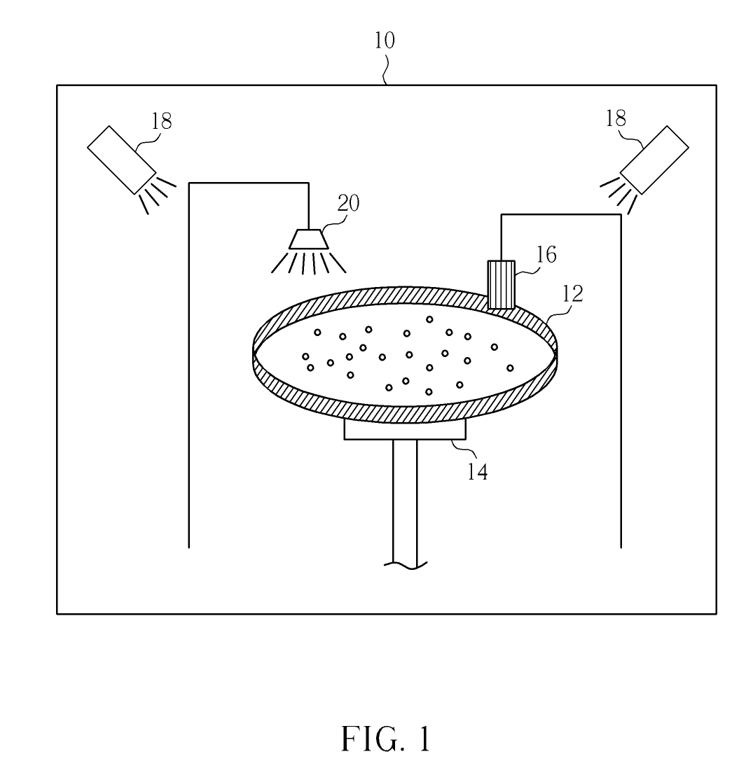

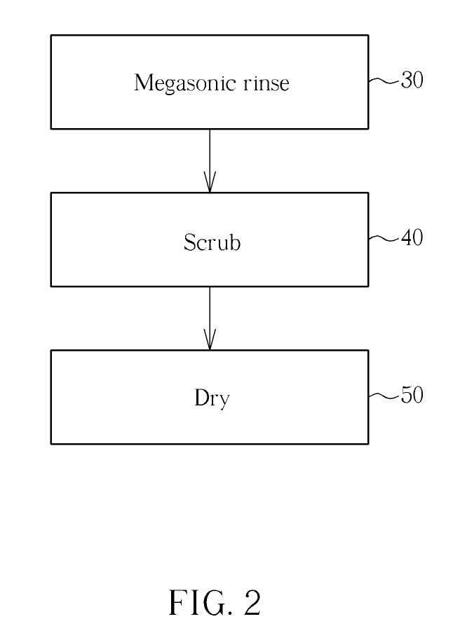

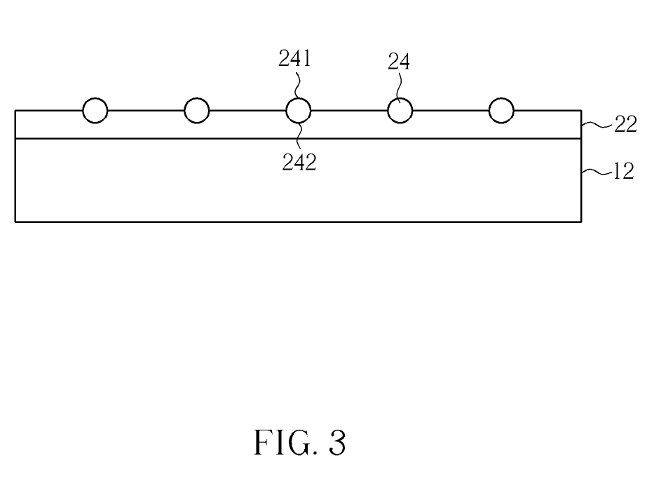

FIG. 1 is a schematic diagram showing germane parts of a wafer cleaning chamber in accordance with a preferred embodiment of the present invention. FIG. 2 is a flow chart depicting a method of cleaning wafer. FIG. 3 is a schematic diagram showing a wafer with a metal layer thereon.

Please refer FIG. 1 and FIG. 2 of the present invention, a wafer cleaning chamber 10 is provided. The wafer cleaning chamber 10 is utilized for cleaning a wafer 12. The cleaning chamber 10 has a wafer stage 14 for supporting and spinning the wafer 12. A brush 16 such as a PVA brush is hanged above the wafer stage 14. At least one liquid nozzle 18 is disposed above the wafer stage 14. The number of the liquid nozzle 18 may be altered depending on different requirements. For example, as shown in FIG. 1, there may be two liquid nozzles 18 positioned at two opposite sites of the wafer stage 14. A megasonic liquid nozzle 20 is disposed above the wafer stage 14.

Please still referring to FIG. 1 and FIG. 2, a method of cleaning a wafer includes the steps as follows. First, a wafer 12 is provided. Then, the wafer 12 is loaded into the wafer cleaning chamber 10 introduced in FIG. 1. Later, a first clean stage 30 including a megasonic rinse is performed. At the first clean stage 30, the wafer 12 is rinsed by jetted liquid introduced with megasonic energy. The liquid can be DI wafer jetted from the megasonic liquid nozzle 20. The megasonic energy has a frequency between 1.4 MHz to 1.6 MHz. Meanwhile, the wafer 12 is rotated by the wafer stage 14. The wafer 12 May be rotated during the entire process.

At the same time, liquid such as DI water is jetted from the two liquid nozzles 18 to rinse the surface of the wafer 12. The liquid from the liquid nozzles 18 can be open or closed due to different requirements, and the liquid from the liquid nozzles 18 is not applied with megasonic energy.

After the first clean stage 30, a second clean stage 40 is performed by scrubbing the wafer 12 by the brush 16. Then, at the last clean stage 50, the wafer is spun to dry. The wafer 12 in the clean chamber 10 could be any kind of wafer needed clean.

According to a preferred embodiment of the present invention, the wafer just after a metal layer formation process is specifically suitable to use the method provided in FIG. 1 and FIG. 2 in the present invention.

The wafer just after a metal layer formation process is shown in FIG. 3, wherein elements with the similar features are designated with the same numerals. As shown in FIG. 3, a wafer 12 has a metal layer 22 on is provided. The metal layer 22 can be Al—Cu alloys, Al or other metals. According to a preferred embodiment of the present invention, the metal layer 22 is Al—Cu alloys. The metal layer 22 may be formed by a chemical vapor deposition process, a physical vapor deposition process or other fabricating processes. Because of the characteristic of the Al—Cu alloys, there are numerous particles such as Al—Cu alloy particles 24 inlaid in a surface of the metal layer 22. More particularly, the particles 24 have an upper part 241 protruding out of the surface of the metal layer 22 and a lower part 242 embedded in the metal layer 22. Therefore, the surface of the metal layer 22 becomes rough which may influence the flatness of the material layer formed afterwards.

To achieve cleaning optimization, the wafer 12 having metal particles 24 shown in FIG. 3 can be cleaned by the method provided in the present invention. Please refer to FIG. 1 to FIG. 3, for example, in the first clean stage 30, the wafer 12 disposed in the cleaning chamber 10 can be rinsed by both DI wafer applying megasonic energy jetted from the megasonic liquid nozzle 20, and DI wafer without applying megasonic energy from the liquid nozzle 18. The duration of the first clean stage 30 could be about 20 seconds, and rotation speed is around 3000 rpm. At this point, the structure of the protruding Al—Cu alloy particles 24 may be deteriorated.

After the first clean stage 30, the second clean stage 40 can be performed by scrubbing the Al—Cu alloy particles 24 protruding out of the surface of the metal layer 22 by the brush 16 for 20 seconds. The rotation speed at the second clean stage 40 is around 3000 rpm. The brush 16 touches the surface of the metal layer 22 during the second clean stage. Then, the protruding Al—Cu alloy particles 24 can be removed from the surface of the metal layer 22. At the final stage 50, the wafer 12 is spun to dry for 15 seconds. At this moment, the method of cleaning a wafer is completed.

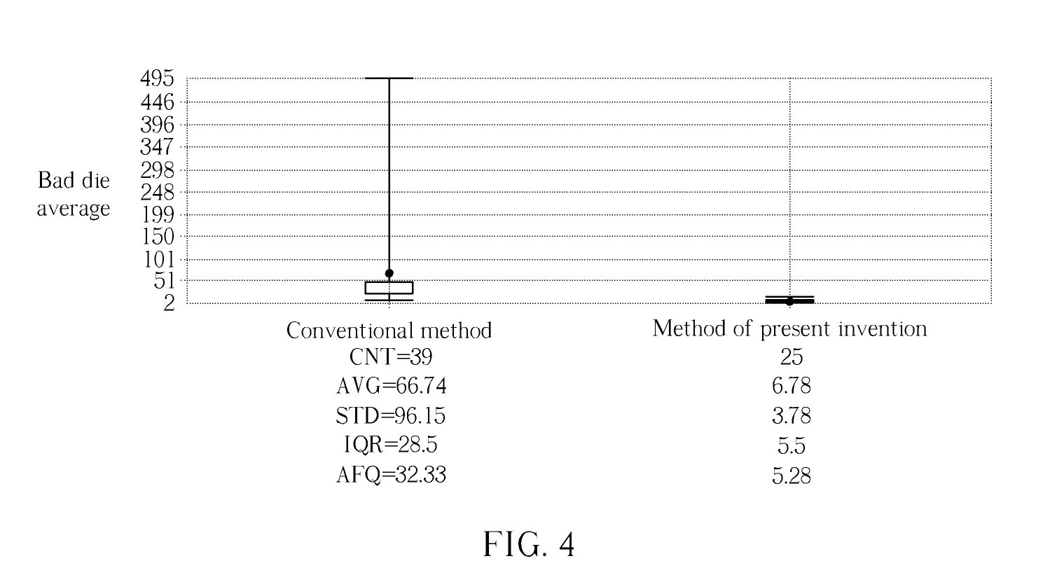

FIG. 4 to FIG. 7 are experimental charts showing chips applied with the conventional clean method and the clean method of the present invention.

FIG. 4 shows quantity of chips occupied by bad dies on a first metal layer when using conventional clean method and the clean method of present invention respectively. The vertical axis represents quantity of chips occupied by bad dies, and the bad dies are on a first metal layer. The horizontal axis represents whether the chip is cleaned by a conventional clean method or the clean method of present invention. As shown in FIG. 4, the quantity of chips occupied by bad dies on the first metal layer is reduced when using the clean method of present invention compared with the conventional method. The first metal layer has a thickness of 4000 angstroms, and has a fabricating temperature of 150° C.

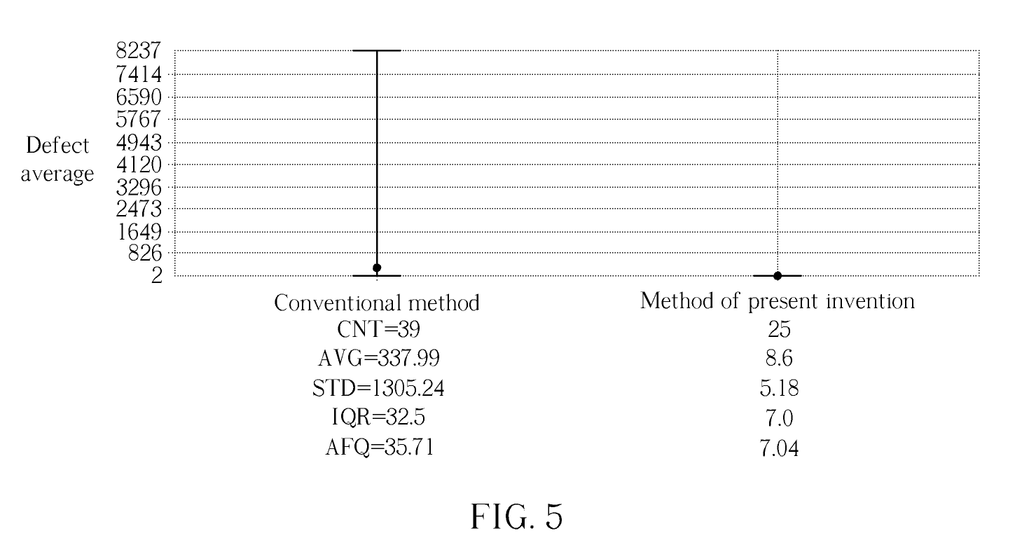

FIG. 5 shows quantity of defects on a first metal layer of a chip when using a conventional clean method and the clean method of present invention respectively. The vertical axis represents quantity of defects on a first metal layer of a chip. The horizontal axis represents whether the chip is cleaned by the conventional clean method or the clean method of present invention. As shown in FIG. 5, the quantity of defects on a first metal layer of a chip is reduced when using the clean method of present invention compared with the conventional method.

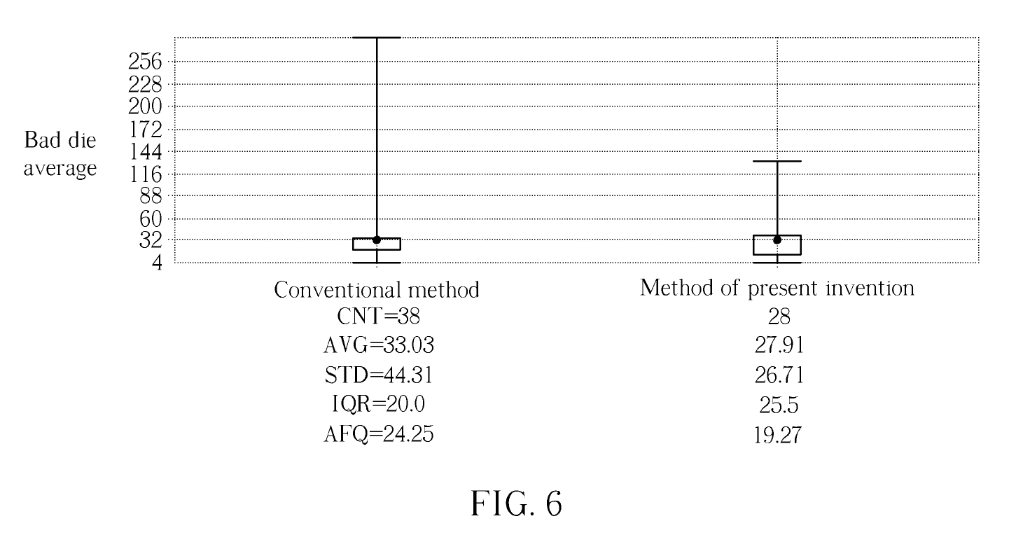

FIG. 6 shows quantity of chips occupied by bad dies on a second metal layer when using a conventional clean method and the clean method of present invention respectively. The vertical axis represents quantity of chips occupied by bad dies, and the bad dies are on a second metal layer. The horizontal axis represents whether the chip is cleaned by the conventional clean method or the clean method of present invention. As shown in FIG. 6, the quantity of chips occupied by bad dies on the second metal layer is reduced when using the clean method of present invention compared with the conventional method. The second metal layer has thickness of 10500 angstroms, and has a fabricating temperature of 440° C.

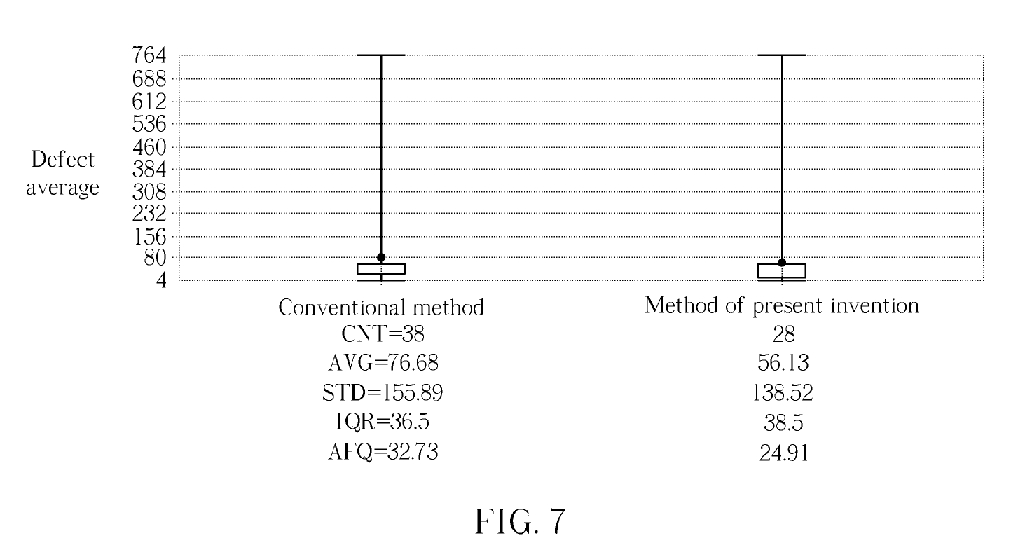

FIG. 7 shows quantity of defects on a second metal layer of a chip when using a conventional clean method and the clean method of present invention respectively. The vertical axis represents quantity of defects on a second metal layer of a chip. The horizontal axis represents whether the chip is cleaned by the conventional clean method or the clean method of present invention. As shown in FIG. 7, the quantity of defects on a second metal layer of a chip is reduced when using the clean method of present invention compared with the conventional method.

One of the features of the present invention is that the megasonic rinse is performed to clean the wafer before using the brush to scrub the wafer. In this way, the clean time is reduced, and the clean result can be better.

Those skilled in the art will readily observe that numerous modifications and alterations of the device and method may be made while retaining the teachings of the invention.

1. A method of cleaning a wafer, comprising:
loading a wafer into a cleaning chamber;
performing a first clean stage to rinse the wafer by jetted liquid introduced with megasonic energy, wherein the megasonic energy has a frequency between 1.4 MHz to 1.6 MHz;
after the first clean stage, performing a second clean stage to scrub the wafer; and
drying the wafer.

2. The method of cleaning a wafer of claim 1, wherein the liquid is DI water.

3. (canceled)

4. The method of cleaning a wafer of claim 1, wherein the cleaning chamber comprises a wafer stage for rotating the wafer.

5. The method of cleaning a wafer of claim 1, wherein a metal layer is disposed on a surface of the wafer.

6. The method of cleaning a wafer of claim 1, wherein the second clean stage is performed by using a rotating brush to scrub the wafer.

7. The method of cleaning a wafer of claim 1, wherein the wafer is dried by spinning the wafer.

8. A method of cleaning a wafer, comprising:
loading a wafer having a metal layer into a cleaning chamber, wherein a plurality of metal particles are inlaid in a surface of the metal layer;
performing a first clean stage to rinse the wafer by jetted liquid introduced with megasonic energy;
after the first clean stage, performing a second clean stage to scrub the wafer; and
drying the wafer.

9. The method of cleaning a wafer of claim 8, wherein the metal layer is composed of Al—Cu alloys.

10. The method of cleaning a wafer of claim 8, wherein after the second clean stage, the plurality of metal particles are removed from the metal layer.

11. The method of cleaning a wafer of claim 8, wherein at least one of the plurality of the metal particles has a upper part protruding out of the surface of the metal layer and a lower part embedded in the metal layer.

12. The method of cleaning a wafer of claim 8, wherein the liquid is DI water.

13. The method of cleaning a wafer of claim 8, wherein the megasonic energy has a frequency between 1.4 MHz to 1.6 MHz.

14. The method of cleaning a wafer of claim 8, wherein the cleaning chamber comprises a wafer stage for rotating the wafer.

15. The method of cleaning a wafer of claim 8, wherein the second clean stage is performed by using a rotating brush to scrub the wafer.

16. The method of cleaning a wafer of claim 8, wherein the wafer is dried by spinning the wafer.
